(19) United States
(12) Patent Application Publication
(10) Pub. No.: US 2012/0237914 A1
(43) Pub. Date: Sep. 20, 2012

(54) Teaching method using virtual in-room teachers and teaching assistants

(76) Inventor: Donald Spector, New York, NY (US)

(21) Appl. No.: 13/199,528

(22) Filed: Sep. 1, 2011

Related U.S. Application Data
(63) Continuation-in-part of application No. 12/316,207, filed on Dec. 10, 2008, now abandoned.
(60) Provisional application No. 61/016,575, filed on Dec. 25, 2007.

(51) Int. Cl. G09B 5/00

(52) U.S. Cl. 434/307 R; 434/309

(57) ABSTRACT

A method for teaching uses lectures performed at a remote location and transmitted to remote computers, in combination with remote teaching assistants. The method has the following steps: performing a lecture; capturing the lecture; transmitting the lecture to a plurality of remote locations either simultaneously with or at a later time than the lecture performance; providing students at each of the remote sites; providing an instructor at another remote site; displaying the lecture for viewing by the students; and providing remote educational support for the students by the instructor.

### CROSS-REFERENCE TO RELATED APPLICATIONS

This application is a continuation-in-part of U.S. patent application Ser. No. 12/316,207, filed on Dec. 10, 2008, which claims priority under 35 U.S.C. 119(e) of U.S. Provisional Application Ser. No. 61/016,575 filed on Dec. 25, 2007.

### BACKGROUND OF THE INVENTION

1. Field of the Invention

This product relates to the field of education and specifically to the telecommunications of a teacher into a classroom or laboratory setting at a school or university. In particular, the invention relates to a method for teaching using lectures performed at a remote location and transmitted to the classroom, in combination with live teaching assistants.

2. The Prior Art

Over the past several decades inroads have been made in the field of long distance learning. However, many believe that the direction of long distance learning, using such technologies such as CU/CMe as well as other long distance technologies have provided sub-quality education. Many accreditation agencies, while understanding the advantages of long distance learning, have begun to turn away from it while on-line for-profit colleges continue to have more legal problems (while still being profitable).

It is often desirable for educational institutions to offer lectures by experts in the field, particularly those who are world-renowned. Of course, for most institutions, this is not possible, as there are only a few of these individuals and their time is limited. The distance learning model, where students view the lectures over their own computers from a remote location, has attempted to address this issue. Nonetheless, the prepackaged distribution of media to students over such vehicles as the Internet loses the one-on-one interaction of the classroom, even when combined with more advanced technologies that allow the participants to communicate electronically. Obviously, some of these courses are easy to do in didactic situations, as opposed to, for example clinical situations. Thus, distance learning itself has many drawbacks, including lack of class participation, the inability to ask questions of a live teacher, and significantly less prestige from a degree earned by distance than at an actual classroom-based university.

It would be desirable if everyone could attend live classes taught by world-renowned professors, but geographical and economic constraints prevent this from happening. There have been several attempts to come up with a solution to provide quality instruction in a classroom setting, using instructors from a remote location. However, these attempts also have drawbacks.

For example, US Patent Application Serial No. 2003/0039945A1 to Dang discloses a remote teaching system whereby the instructor's lecture is broadcast to several remote locations, and is assisted by a moderator. However, this situation still suffers from the drawback that the actual teacher is unavailable to assist the students. Similar systems are disclosed in U.S. Pat. No. 5,850,250 to Konopka et al. and U.S. Pat. No. 5,537,141 to Harper et al. All of these systems suffer from the drawback that the actual instructor is located in a remote location and is unavailable to directly interact with the students. This can lead to inattention and frustration from the student body, and thus poor academic performance.

### SUMMARY OF THE INVENTION

It is the object of this invention to provide the inverse to this situation as well as provide an economic basis to provide superior teachers to institutions of learning while preserving the atmosphere of the classroom, which has produced excellent results over many years.

The invention provides a teaching system that uses recorded lectures from well known experts in the field, in conjunction with live teaching assistants, who run the class. The use of live teaching assistants provides the direct interaction with the students that they need, while the lectures provide the expertise needed to provide a high-quality education in places where it would normally be lacking.

The invention comprises the steps of:

performing a lecture;

recording the lecture;

transmitting the lecture to a plurality of remote locations either simultaneously with or at a later time than the lecture performance;

providing a student at each of the remote sites;

providing an instructor at another remote site;

displaying the lecture for viewing by the students;

providing educational support for the students by the instructor, who is available for live conversations with the students.

The term “recording” as used herein refers to any method of filming or recording the lecture, whether via digital equipment, analog equipment, actual film, software, or any other media. With the invention, the lecture is delivered in a classroom with a teaching assistant, but like a telecommunication conference, can reach several rooms and/or campuses simultaneously. It can also be delivered by a teacher from any suitable location such as an office or conference room, as opposed to the lecture hall. In a sense this is not long distance learning, but is in fact “long distance teaching”. It is conducted from a remote location, but there is two way communication with the instructor, and it can be used for both didactic as well as clinical training. It is accepted by all forms of accreditation. The teacher can either be counted as a “live” teacher for purposes of accreditation, where the lecture is transmitted simultaneously to the remote sites, and where the teacher answers live questions, through either individual transmissions by the students as well as transmission by the teacher, or by a teaching assistant transmitting answers to the students. In cases where the lecture may be recorded and broadcast at a later time to the students, the teaching assistant is still available a the time of the broadcast to assist in the class in a live manner, and the broadcast lecture can be referred to as “teaching material.” There are various combinations and permutations in between these positions.

While prior art has shown the use of teaching materials, whether they be in the form of film, computerized presentations or other programmed material, these materials do not duplicate the personality of the specific teacher that teaches his class with the assistance of teachers and teaching assistants on hand at the remote sites.

Thus, a world famous authority on a subject (who may be a great teacher) may not have the time to teach a small class, yet he may have a specific class which is very valuable to students. Rather than this teacher being used as a teaching material in someone else's class, this teacher teaches his own class and has teaching assistants and local teachers, who meet the legal accreditation requirements for in classroom teaching, while delivering the course of a great teacher. An example might have been a basic physics course as taught by Albert Einstein. Learning from one of the greatest physicists in the world and hearing his approach to basic physics would have been an invaluable asset to many people studying this field. However, Einstein only had time for a few students, and other than the Institute of Advanced Physics in Princeton; few had the privilege of learning from this master. Had a course been developed either live or broadcast to be transmitted to students' computers, with assistant teachers acting as remote aides to the class, such a program could have reached students from many universities and continued after the life of this scholar. There are many such situations in education where presently some of the greatest scholars and teachers in the world have only bits and pieces of their knowledge base stored, while teachers of lesser quality duplicate these courses a thousand fold throughout the country.

The present patent foresees a merging between the media business and the educational industry to create high quality programming and courses that cut across many schools and provide an economic base to have the greatest scholars and teachers of our time reach the maximum number of students in a distance learning setting.

It is also understood that these materials can be used with technologies, such as those described in earlier patents and applications to provide a basis for long distance learning, in a more classical setting where teachers and/or assistants balance out the missing components presently created by long distance learning. It will be the job of the media to edit part of these materials for use into the long distance learning model to create yet another economic base for this model as distinct from this instant application.

In the present invention, the remote previously recorded instructors are melded with the live remote teaching assistant into a seamless program. The system can use an automatic translation software so that the lectures can be broadcast in any language desired by the students. This way, a single lecture can be used around the world, regardless of the native language of the students.

While Einstein is an exception, the low production cost associated with developing courses by famous people, who already have the knowledge base that can be formatted into curriculums, can be of real economic as well as historic and social importance. Furthermore, the teachers and assistant teachers can provide materials so that only a certain proportion of the material has to be presented by a master, so that the great teacher can be updated by the assistant teacher as well as having the assistant teacher answer and go over some of the questions and requisite testing and more tedious parts of the academic process. This would make the preparation of materials more palatable to people of greater distinction.

This form of learning envisions a new framework in which materials are merged with digital technologies for new forms of transmission, broadcast and adaptation to make the stream of information more relevant to present and future technologies.

The “long distance teacher” as a means to qualify under present accreditation standards, as well as bring the best of traditional and on line teaching forms the underpinning of the invention.

The technical aspects of the invention can be accomplished by any known means. For example, the step of filming could be accomplished with any known video or digital camera equipment, using any suitable technologies for recording and transfer of the image and audio information. For live transmission, commercially available videoconferencing technology could be employed. Alternatively, the transmission could occur by recording the lecture on a medium such as a DVD and physically bringing the DVD to the remote site for playback there. The transmission could occur via streaming the video to the remote sites over the internet. Any other suitable means for transmission or audio and video data could also be used.

### BRIEF DESCRIPTION OF THE DRAWING

Other objects and features of the present invention will become apparent from the following detailed description considered in connection with the accompanying drawing. It is to be understood, however, that the drawing is designed as an illustration only and not as a definition of the limits of the invention.

FIG. 1 shows a schematic block diagram of the method according to the invention.

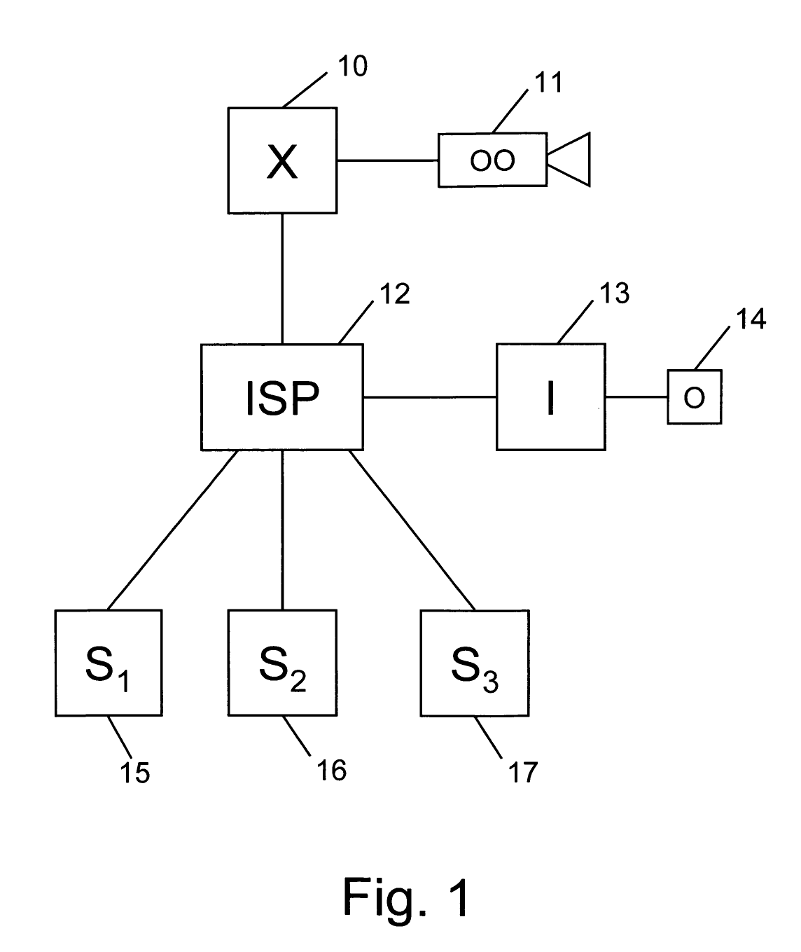

### DETAILED DESCRIPTION OF THE PREFERRED EMBODIMENTS

The invention will now be described with reference to the following two examples. The examples are for illustration purposes only and do not limit the invention.

### Example 1

### Live Lecture

In this scenario, Professor X, a world-renowned expert, gives a lecture in a first location, such as his office or regular classroom. This lecture is filmed on a digital video camera 11 connected to a computer 10 with a high-speed internet connection, connected to ISP server 12. The lecture is transmitted instantaneously through the internet connection using videoconferencing software to a computer 15, 16, 17 at each of several remote student locations. These locations could be anywhere in the world. Physical proximity is not a requirement with the invention. The computer at each remote location is connected to speakers. The lecture is also transmitted to a computer 13 of a teaching assistant located at another remote location.

There could be a camera 14 stationed at the remote location of the teaching assistant and connected to the computer 13, for sending images and audio to the students, so that there is actual interaction between the class and the teaching assistant. This could also be possible with Professor X as well, so that there could be conversations between the teaching assistant and Professor X, as well as between the students and the teaching assistant, and even between the students and Professor X. In this embodiment, the students can communicate to professor X and the teaching assistant via email or other type of electronic messaging during the lecture, with questions. The instructor at the remote classroom site can also communicate with Professor X during the lecture, either via the camera or via email or other electronic messaging.

The class is run by the instructor at the remote site, who can also answer questions from the students, give tests, assign homework and grade the students, all remotely via computer. The instructor at the remote site acts as the main teacher for the students, with assistance from Professor X, who provides expertise with the lecture. This way, the students obtain the full benefit of “live” class, while not requiring the physical presence of Professor X or the teaching assistant, and reducing the administrative demands on Professor X.

### Example 2

### Pre-Recorded Lecture

In this scenario, Professor X gives a lecture in his classroom or office, and the lecture is filmed via a camera and recorded on a recordable medium, such as a Digital Video Disc (DVD). Other media, such as a flash drive, hard drive, Video Cassette Tape, CD-ROm, or any other suitable medium could also be used. Alternatively, the lecture is stored on a remote server and retrieved via an internet connection when it is needed. This lecture is then transferred to the remote computers for playback during the class time.

This embodiment has the advantage that the class can be given at any day or time, regardless of when the lecture is actually performed by Professor X. It also enables the instructor to stop the lecture at different times to answer questions, and to re-play parts of the lecture for clarification purposes. The instructor could be given control over the playback of the lecture to the students, so that the instructor can interrupt the lecture at any time. The students could also access the lecture outside of class for study purposes. In this embodiment as well, the instructor acts as the teacher, and uses the recorded lecture as a resource during the class time. All of the testing, grading, homework and other tasks are managed by the instructor, not Professor X.

In all of the embodiments, the lecture by Professor X can take the entire class time, or only a portion of the class time, with the remaining class time being used for teaching by the instructor on a remote basis. In one embodiment the lecture amounts to ½ of the class time.

In another embodiment, the lecture is translated into the native language of the students, via a voice-over or subtitles displayed on the screen. The translation can be done manually, by a human translator, or can be done automatically by translating software, that automatically uploads the translation as the lecture is being transmitted. This way, the lecture can be used all over the world, regardless of the native language of the lecturer. In another embodiment, the lecture is translated by software on the student's computer, so that the student can select the language in which the lecture is to be broadcast. The teaching assistant conducts the class in the native language of the students, but the lecture could have been given in any language.

Accordingly, while only a few embodiments of the present invention have been shown and described, it is obvious that many changes and modifications may be made thereunto without departing from the spirit and scope of the invention.

What is claimed is:

1. A method for teaching, comprising:
performing a lecture at a first location;
recording the lecture during the step of performing;
transmitting the lecture to a computer at each of a plurality of other locations remote from said first location;
providing students at each of the remote locations;
providing an instructor and a computer at another remote location;
displaying the lecture for viewing on the computers by the students and instructor; and
providing educational support for the students by the instructor by transmitting information from the instructor's computer to the students' computers.

2. The method according to claim 1, wherein the step of transmitting comprises sending a copy of the recorded lecture to each of the remote locations, and wherein said step of displaying takes place after said steps of performing and capturing are completed.

3. The method according to claim 1, wherein the lecture is transmitted and displayed simultaneously with the step of performing and recording.

4. The method according to claim 2, wherein the step of recording includes copying the lecture onto a DVD.

5. The method according to claim 1, wherein the instructor is a teaching assistant.

6. The method according to claim 1, further comprising the step of evaluating the students by the instructor.

7. The method according to claim 1, wherein the lecture lasts approximately ½ of the length of a class in which the lecture is played.

8. The method according to claim 1, wherein the lecture is displayed on a single screen at each remote location.

9. The method according to claim 3, further comprising the step of viewing the students and instructor at each remote location from said first location.

10. The method according to claim 9, wherein said step of viewing takes place via a camera stationed at each remote location, said camera sending images and audio to a screen at said first location.

11. The method according to claim 1, further comprising the step of preparing a translation of the lecture and transmitting the translation such that the translation is viewed or heard simultaneous with said step of displaying.

12. The method according to claim 11, wherein the step of preparing a translation is performed automatically by a computer program installed in at least one of the remote computers.

13. The method according to claim 12, wherein the computer program is configured to translate the lecture into a plurality of languages, such that a user can select the language in which the lecture is to be translated.
